(19) United States
(12) Patent Application Publication
(10) Pub. No.: US 2002/0075874 A1
(43) Pub. Date: Jun. 20, 2002

(54) Datagram transmission device

(76) Inventors: Takahiro Yamashita, Chiba (JP); Kei Kato, Chiba (JP); Shigeo Miki, Kanagawa (JP)

Correspondence Address: VENABLE, BAETJER, HOWARD AND CIVILETTI, LLP, P.O. BOX 34385, WASHINGTON, DC, 20043-9998, US

(21) Appl. No.: 10/005,123

(22) Filed: Dec. 7, 2001

(30) Foreign Application Priority Data
Dec. 15, 2000 (JP) 381436/2000

(51) Int. Cl. H04L 12/28; H04L 12/56

(52) U.S. Cl. 370/395.2; 370/389

(57) ABSTRACT

A datagram transmission device whereby processing for performing determination of the transmission destination and transmission using the destination address and processing using information of layers other than the third layer of the protocol are performed by a simple algorithm. A first search function section searches for a transmission control rule using the destination address i.e. third layer information of a received datagram. A second search function section searches for a transmission control rule using information of this datagram other than the third layer. A decision function section inputs the search result of the second search function section and determines a transmission control rule that is contained in all the search results. A transmission control execution section executes action in accordance with the transmission control rule decided by the decision function section, specifically, searching and setting processing of the transmission route, transmission processing, processing to deny transmission, and processing to perform datagram copying etc.

### BACKGROUND OF THE INVENTION

1. Field of the Invention

The present invention relates to a datagram transmission device that relays datagrams within a communication network.

2. Description of Related Art

In a communication network such as an LAN (local area network) or the Internet, datagrams such as packets are relayed by datagram transmission devices. Known datagram transmission devices include for example routers or switches.

Known technology concerning datagram transmission devices is disclosed for example in the following references.

Reference 1: Laid-open Japanese Patent Publication No. 2000-188608

Reference 2: Laid-open Japanese Patent Publication No. 2000-32056

Reference 3: Laid-open Japanese Patent Publication No. 2000-32003.

In a datagram transmission device, the transmission destination is ascertained using the destination address which belongs the information of the third layer of the protocol (see above Reference 1).

Also, for example a route search algorithm called the dichotomizing search method is employed as a technique for determining the transmission destination from the destination address (see above Reference 1). The dichotomizing search method is a method in which a route is searched for using a map of tree structure constructed by joining large numbers of nodes having a single input and two outputs i.e. pointers. In this method, a node at which the target route entry is mapped is found by following nodes in accordance with whether the subject bit is 1 or 0.

Furthermore, Reference 1 discloses a technique of speeding up the route search using the dichotomizing search method by converting P dichotomizing branch levels into a single tree of 2^{P} branches (hereinbelow, this is termed a “2^{P} search”). With this technique, searching of P branch levels can be performed by a single process, so the time required for the search can be reduced by factor of 1/P.

In recent years, datagram transmission devices have appeared that do not merely transmit datagrams but also control the quality of communication etc of the transmitted datagrams(see the above references 2 and 3). In addition to searching for a route to the transmission destination using the information of the third layer of the protocol, such datagram transmission devices search for optimum communication conditions using the information of the fourth to seventh layers.

In addition, in recent years, datagram transmission devices are being demanded with functions such as a function of determining the priority order of transmission in accordance with the type of datagram (for example the type of application etc) or a function of monitoring datagrams in accordance with prescribed conditions (for example the condition of the transfer source address etc). In order to realize these functions, searching of the processing conditions using the information of the fourth layer and above is necessary.

However, if a search based on the information of other layers (fourth to seventh layers etc) is simply directly added to the route search based on the information of the third layer, the search processing algorithm becomes extremely complicated. In the case of linear searching using the dichotomizing search method described above, the processing time of the datagram transmission device therefore becomes long.

### SUMMARY OF THE INVENTION

An object of the present invention is to provide a datagram transmission device whereby route searching and other searching can be executed with high speed.

Accordingly, a datagram transmission device according to the present invention comprises: first search means that reads the destination address from a received datagram and searches for a transmission control rule corresponding to the destination address; second search means that reads prescribed information other than the destination address information from the datagram and that searches for a transmission control rule corresponding to the information that has thus been read; decision means that respectively inputs search results from the first and second search means and determines a transmission control rule contained in the search results of all the search means; and execution means that executes transmission control in accordance with the transmission control rule determined by the decision means.

The construction of the present invention makes it possible for the datagram transmission device to execute search processing based on attribute information of a plurality of types individually. The search processing algorithm is therefore simple and these search processes can be executed in parallel. In this way, a datagram transmission device according to the present invention can execute transmission control based on attribute information of a plurality of types at high speed.

### BRIEF DESCRIPTION OF THE DRAWINGS

Other objects and advantages of the present invention are described below with reference to the appended drawings.

FIG. 1 is a block diagram illustrating the functional layout of major parts of a datagram transmission device according to a first embodiment;

FIG. 2 is a diagram given in explanation of the node layout of the datagram transmission device illustrated in FIG. 1;

FIG. 3 is a diagram given in explanation of the transmission control rule of the datagram transmission device illustrated in FIG. 1;

FIG. 4 is a block diagram illustrating the functional layout of major parts of a datagram transmission device according to a second embodiment;

FIG. 5 is a diagram given in explanation of the node layout of the datagram transmission device illustrated in FIG. 4;

FIG. 6 is a diagram given in explanation of the bit map layout of the datagram transmission device illustrated in FIG. 4; and

FIG. 7 is a flowchart given in explanation of the overall operation of the datagram transmission device illustrated in FIG. 4.

### DESCRIPTION OF THE PREFERRED EMBODIMENTS

Embodiments of the present invention are described below with reference to the drawings. The size, shape and arrangement relationships of the various constituent components in the Figures are only shown diagrammatically to an extent such as to enable understanding of the present invention and the numerical values given below are merely by way of example only.

First Embodiment

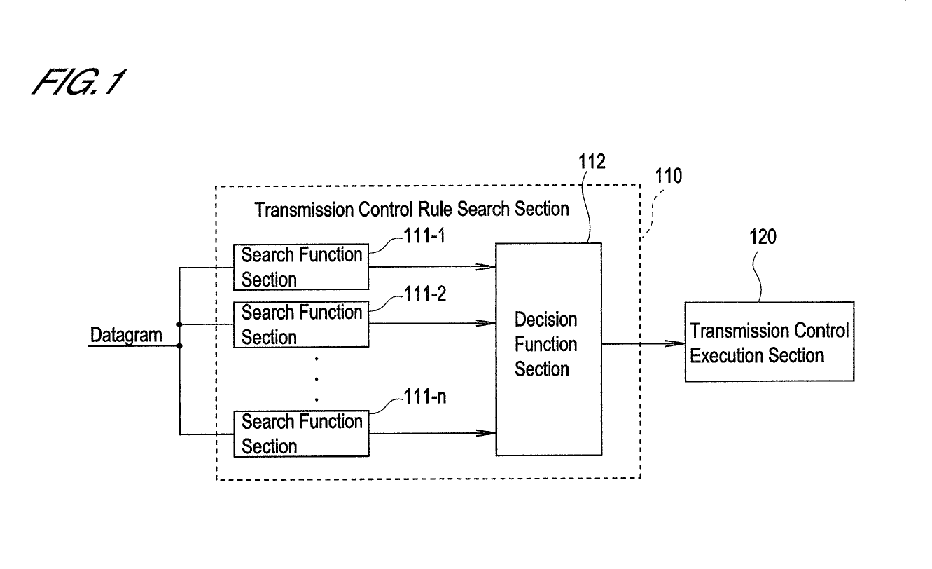

A datagram transmission device according to a first embodiment of the present invention is described with reference to FIG. 1 to FIG. 3.

FIG. 1 is a block diagram illustrating conceptually the functional layout of major parts of a datagram transmission device according to this embodiment.

As shown in FIG. 1, this datagram transmission device comprises a transmission control rule search section 110 and a transmission control execution section 120.

Transmission control rule search section 110 comprises n search function sections 111-1 to 11-n and a decision function section 112. Search function sections 111-1 to 111-n respectively perform search functions in parallel.

The first search function section 111-1 extracts the destination address from the received datagram and performs a search in order to specify a transmission control rule corresponding to this destination address. Any search processing algorithm may be employed, but in this embodiment the 2^{P} search described above is employed. Search function section 111-1 comprises a branch structure of nodes for performing 2^{P} searching and a memory region for storing a transmission control rule chain. A transmission control rule chain is a group of data consisting of the transfer control rules corresponding to the node in the form of a chain, and is constructed for each node.

The remaining search function sections 111-2 to 111-n extract prescribed attribute information, which is not the destination address, from a received datagram and perform a search for specifying a transmission control rule corresponding to this attribute information. Information belonging to the third layer or information belonging to the fourth or higher layers is selected as this attribute information. In this embodiment, 2^{P} searching is employed as the search processing algorithm for this also. Search function sections 111-2 to 111-n are provided with a node branch structure and memory region storing the transmission control rule chain, for each search function section.

Decision function section 112 inputs the search results from each search function section 111-1 to 111-n and finds the logical product of these search results. That is, decision function section 112 inputs from search function sections 111-1 to 111-n the transmission control rules specified by these searches and selects from these transmission control rules a transmission control rule that is contained in all the search results.

Transmission control execution section 120 executes action (transmission control) in accordance with the transmission control rule selected by decision function section 112. By this action, searching and setting of the transmission route, transmission, denial of transmission, determination of priority order, and monitoring of datagrams etc are performed in accordance with the selected transmission control rules.

It should be noted that, in this embodiment, the various transmission control rules are generated such that the target transmission control can be performed by executing the transmission control rules obtained by this logical product calculation. For example, if it is desired to perform transmission control such that transmission of electronic mail whose destination address is A and source address is B is refused, search function section 111-1 is arranged so as to provide a transmission control rule whereby the search result when the destination address A is input indicates “transmission denied”, search function section 111-2 is arranged such as to provide a transmission control rule whereby the search result when source address B is input indicates “transmission denied” and search function section 111-3 is arranged such as to provide a transmission control rule whereby the search result when the data type is electronic mail indicates “transmission denied”.

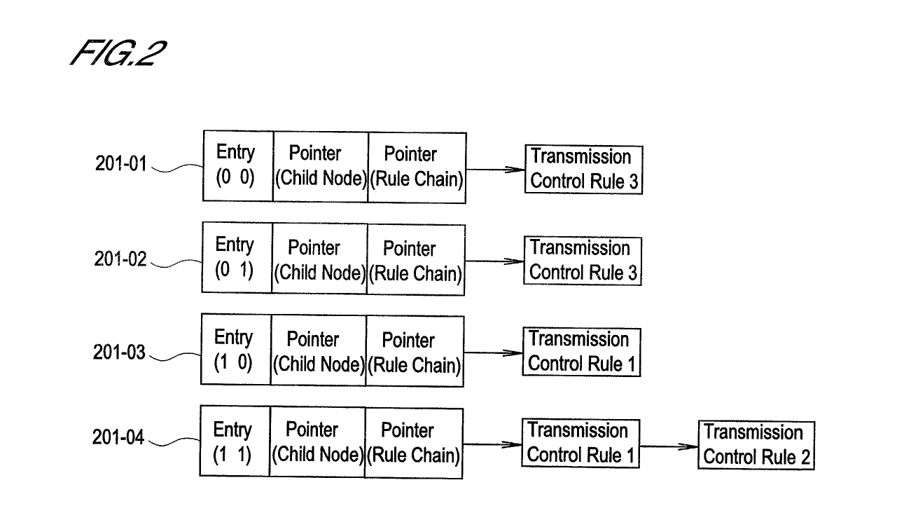

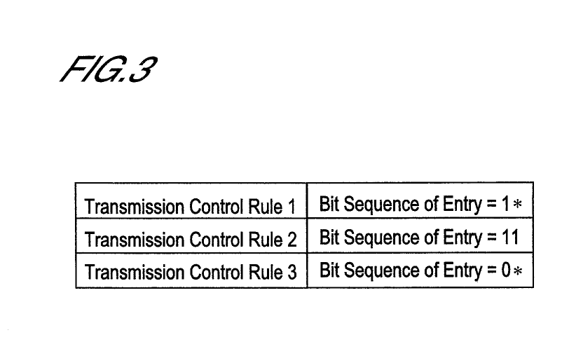

Next, the principles of operation of the datagram transmission device shown in FIG. 1 will be described using FIG. 2 and FIG. 3.

FIG. 2 is a diagram illustrating an example of a first level node arrangement of a search function section.

As described above, search function sections 111-1 to 111-n acquire attribute information (destination address or non-destination-address information) used by the search function section from the received datagram. A node corresponding to the value of the high order m bits (in this case assumed to be two bits) of such attribute information is then selected from among nodes 201-1 to 201-4. That is, different nodes are selected when the high order two bits are “00”, when they are “01”, when they are “10” and when they are “11”. As shown in FIG. 2, at these nodes 201-1 to 201-4 there are respectively stored a pointer for movement to the corresponding child node (i.e. the next level node) and a pointer of the corresponding transmission control rule chain. In this context, a pointer consists in information such as for example the address or index specifying the subject child node and/or transmission control rule chain. From 0 to 2^{m} child node pointers are stored at each node (where m=2). These child node pointers are selected in accordance with the value of the next m bits of the attribute information. If there is no child node corresponding to the value of the next m bits, the search function section specifies a transmission control rule chain in accordance with the pointer of the transmission control rule chain.

FIG. 3 is a table showing an example of the correspondence relationship of the value of the high order two bits of the attribute information and the transmission control rule. In the example of FIG. 3, transmission control rule 1 corresponds to high order two bits “1*” (where * indicates either of 0 or 1), transmission control rule 2 corresponds to high order two bits “11”, and transmission control rule 3 corresponds to high order two bits “0*”.

Consequently, as shown in FIG. 2, only transmission control rule 3 is stored in the transmission control rule chain corresponding to node 201-1 of the high order two bits “00”; only transmission control rule 3 is stored in the transmission control rule chain corresponding to the node 201-2 of high order two bits “01”; only transmission control rule 1 is stored in the transmission control rule chain corresponding to node 201-3 of the high order two bits “10”; and transmission control rule 1 and transmission control rule 2 are stored in the transmission control rule chain corresponding to node 201-4 of high order two bits “11”.

The child nodes corresponding to these nodes also respectively have the same constitution as in FIG. 2. Hereinafter in the same way, the nodes of a plurality of levels are constituted within search function sections 111-1 to 111-n. However, the final level nodes of each branch respectively do not have a child node pointer but only have a transmission control rule chain pointer.

If there is a corresponding child node at each node that is passed through, the search function section moves to this child node; if there is no corresponding child node, it specifies a transmission control rule. In this search method, the transmission control rule of the node whereof the number of bits that coincide with the attribute information is largest i.e. the node of longest mask length is selected. This search method is generally called the longest coincidence search.

In this way, search function sections 111-1 to 111-n respectively find one or a plurality of transmission control rules. The search results are sent to decision function section 112. Thus, as described above, one or other (or a plurality) of transmission control rules is selected by decision function section 112 and, in addition, transmission control execution section 120 executes action in accordance with the selected transmission control rule.

As described above, with a datagram transmission device according to this embodiment, search processing is individually executed in accordance with the plurality of types of attribute information, so the search processing algorithm can be simplified and furthermore it is easy to execute these search processes in parallel. Consequently, with a datagram transmission device according to this embodiment, transmission control in accordance with a plurality of types of attribute information can be executed at high speed.

Second Embodiment

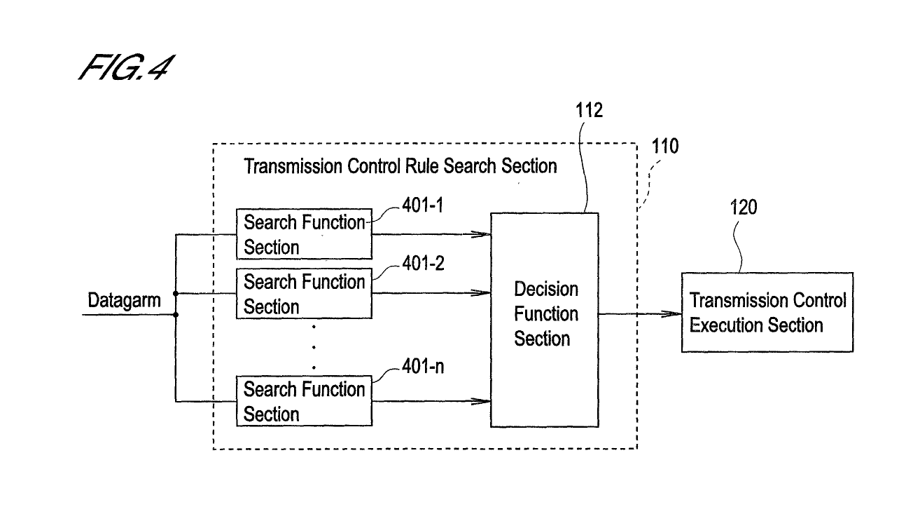

Next, a datagram transmission device according to a second embodiment of the present invention is described with reference to FIG. 4 to FIG. 7.

FIG. 4 is a block diagram illustrating schematically the functional layout of major portions of a datagram transmission device according to this embodiment. In FIG. 4, structural elements given the same reference symbols as in FIG. 1 respectively indicate items that are the same as in the case of FIG. 1.

Search function sections 401-1 to 401-n respectively perform search processing in parallel. Search function section 401-1 extracts the destination address from a received datagram and performs a search for identifying the transmission control rule corresponding to this destination address. On the other hand, the remaining search function sections 401-2 to 401-n extract prescribed attribute information other than the destination address from the received datagram, and perform searching for identifying a transmission control rule corresponding to these items of attribute information. As the attribute information of search function sections 401-2 to 401-n, information belonging to the third layer or fourth layer or thereabove is selected. In the same way as in the case of the first embodiment, 2^{P} searching is assumed to be employed as the search processing algorithm.

Search function sections 401-1 to 401-n comprise branch structures of nodes for performing 2^{P} searching and chains of transmission control rules that are the subject of searching. In a datagram transmission device according to this embodiment, each node comprises, in addition to child node pointers and transmission control rule chain pointers, a bit map for referencing the transmission control rule chains of other nodes.

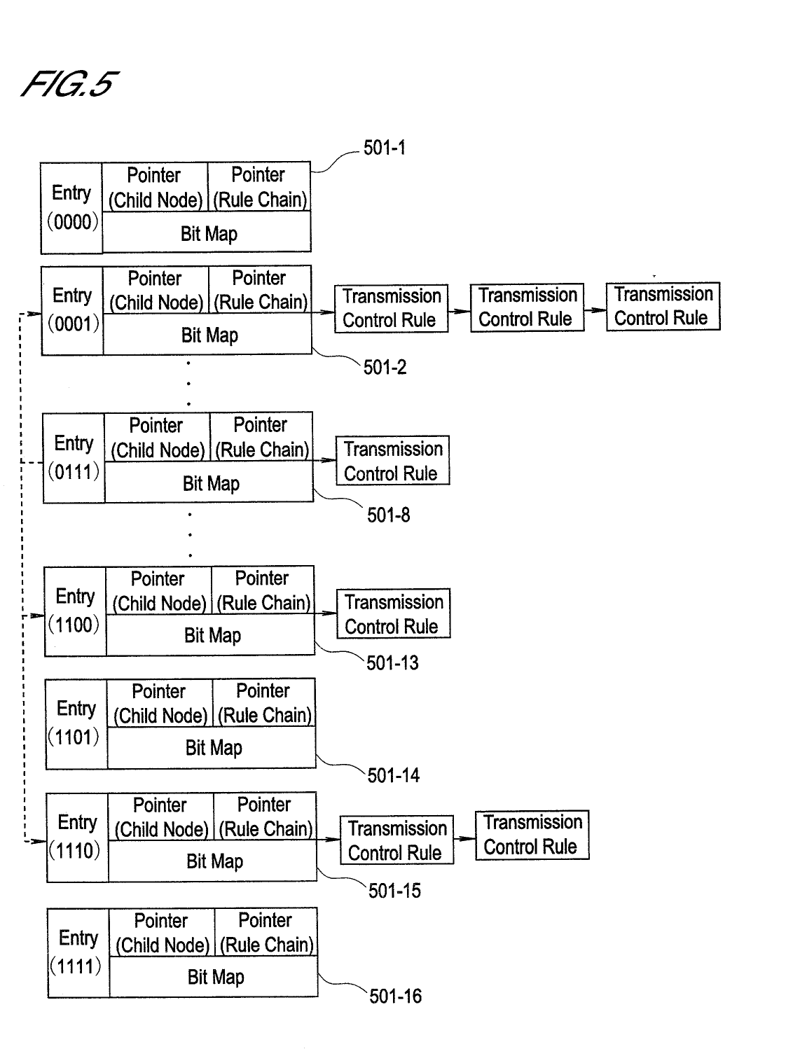

FIG. 5 is a diagram illustrating the first level node layout. In the same way as in the case of the first embodiment, the search function sections 401-1 to 401-n acquire from a received datagram the attribute information (destination address or non-destination-address information) employed by the search function sections. A node corresponding to the value of the high order m bits (in this case assumed to be four bits) of this attribute information is then selected. Search function sections 401-1 to 401-n respectively comprise as first level nodes 2^{m} (in this case 16) nodes 501-1 to 501-16. As shown in FIG. 5, in these nodes 501-1 to 501-16 there are respectively stored pointers for movement to the corresponding child node, pointers of the corresponding transmission control rule chain, and bit maps for referencing the transmission control rule chains of other nodes.

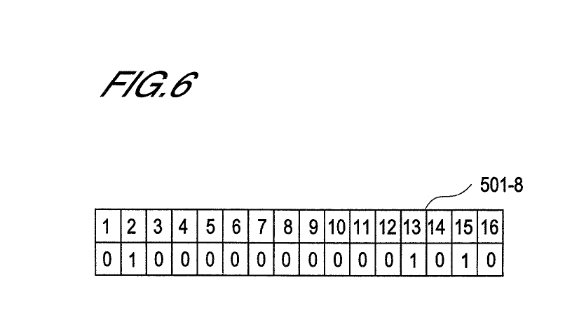

FIG. 6 is a diagram given in explanation of the bit map layout of node 501-8. The bit map layout of the other nodes 501-1 to 501-7, 501-9 to 501-16 is identical.

In the bit map of FIG. 6, the top level indicates the node numbers and the lower level indicates whether or not the transmission control rule chain of the node in question is referenced. In the example of FIG. 6, the bit values corresponding to node numbers “2”, “13”, and “15” are “1” and the bit values corresponding to the other node numbers are “0”. This indicates that node 501-8 references a transmission control rule chain corresponding to nodes 501-2, 501-13, and 501-15 but does not reference transmission control rule chains corresponding to other nodes.

The child nodes corresponding to these nodes respectively have a layout identical with that of FIG. 5. Hereinbelow in the same way, nodes of a plurality of levels are constituted within search function sections 401-1 to 401-n. However, the final level nodes of each branch are respectively not provided with child node pointers but are only provided with transmission control rule chain pointers and bit maps.

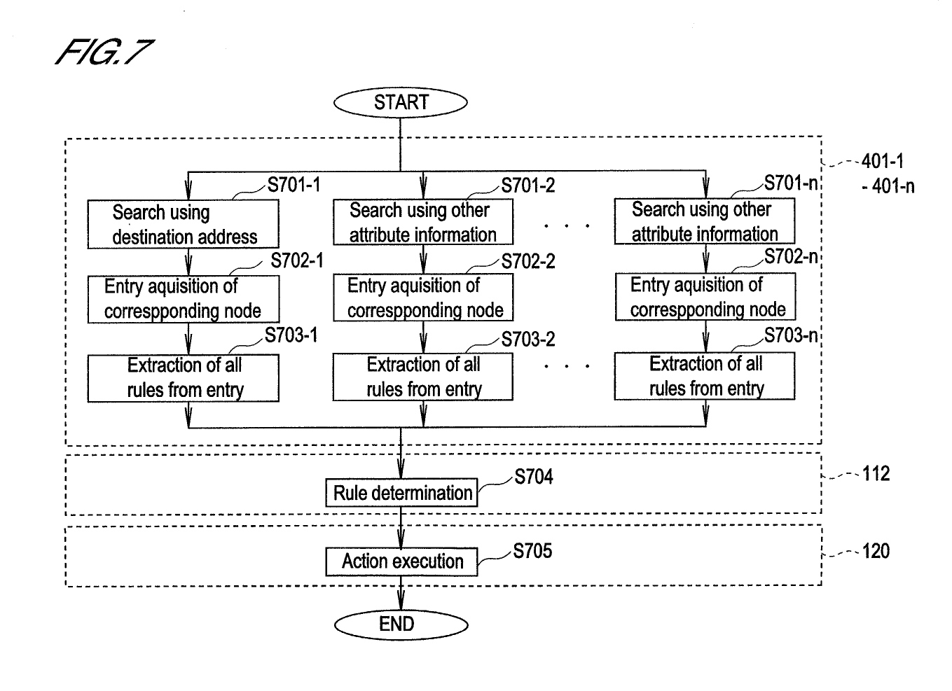

FIG. 7 is a flowchart given in explanation of the operation of a datagram transmission device according to this embodiment.

First of all, when a datagram is received from the network, search function sections 401-1 to 401-n execute search processing in parallel (see S701-1, . . . S701-n). In this search processing, first of all, search function sections 401-1 to 401-n read attribute information from the datagram and select one or other of the first level nodes in accordance with the value of the high order m bits of this attribute information. If there is a corresponding child node at these nodes, processing shifts to this child node.

Next, when a node is reached at which no corresponding child node is present, the search function section executes processing for acquiring the entry of the transmission control rule chain (see S702-1, . . . S702-n). In this processing, the search function sections first of all read the pointers stored at the node in question. Next, the search function section uses the bit map to ascertain the referenced node, and reads the pointer of the transmission control rule chain from the referenced node.

Next, the search function section sequentially extracts (see S703-1, . . . S703-n) the transmission control rule from the transmission control rule chain corresponding to these pointers. The extracted transmission control rules are sent as search results to decision function section 112 (see FIG. 4).

Next, in the same way as in the case of the first embodiment, decision function section 112 finds the logical product of these search results (see S704). The transmission control rule selected by this logical product calculation is sent to transmission control execution section 120.

Finally, transmission control execution section 120 executes action (see S705) in accordance with the transmission control rule selected by the decision function section 112.

As described above, with the datagram transmission device according to this embodiment, transmission control rule chains of other nodes are referenced using a bit map. The transmission control rule chains therefore do not need to contain all of the transmission control rules corresponding to this node, but may contain merely transmission control rules that cannot be extracted by referencing the other transmission control rule chains. If identical transmission rules are stored in duplicated fashion in a plurality of transmission control rule chains, the memory capacity of the datagram transmission device must be increased to that extent. In contrast, in this embodiment, such duplicated storage can be reduced, so the memory capacity can be decreased.

In addition, within a datagram transmission device according to this embodiment, just as in the case of the first embodiment, searching processing is individually executed based on a plurality of types of attribute information, so the search processing algorithm can be simplified and transmission control can be executed at high speed by executing these search processes in parallel.

In the first and second embodiments described above, transmission control rule search section 110 is arranged so as to perform logical product processing by executing search processing using the other items of attribute information even in the case where it is desired merely to perform only transmission in accordance with destination address. However, when only transmission is effected in accordance with destination address, searching based on other attribute information is unnecessary. Consequently, in cases where the action decided upon is only transmission, a further increase in transmission processing speed can be achieved if it is then arranged to interrupt searching based on other items of attribute information and to immediately execute transmission. For example, decision function section 112 may be arranged such that, in cases where the content of the transmission control rule that is input from search function section 111-1 (or 401-1) is checked and this rule indicates only execution of transmission, searching processing by the other search function sections 111-2 to 111-n, 401-2 to 401-n is immediately interrupted and this transmission control rule is sent to transmission control execution section 120 as the result of the logical product calculation.

Also, in the first and second embodiments described above, it was arranged for searching to be performed using the attribute information of the third layer of the protocol or layers higher than this in search function sections 111-2 to 111-n, 401-2 to 401-n. However, in existing communication networks, transmission processing using the attribute information of the second layer is also still utilized. In contrast, a datagram transmission device according to the present invention can also be utilized for transmission using the attribute information of the second layer. For example, if the second layer is ATM (asynchronous transfer mode), the case may be considered of finding a transmission route taking into account virtual channel identifier (VCI) and destination address. In such cases, it may be arranged to acquire route information of a virtual channel by one or other search function section, to acquire route information of the destination address by some other search function section, and to transmit the datagram by this route if these items of route information agree. If this is done, in order to have a search function section acquire route information, route information may be stored in memory within the datagram transmission device instead of transmission control rules. In this way, transmission control using second layer information may be executed at high speed.

In the first and second embodiments described above, it was arranged for logical product calculation to be executed by decision function section 112 after searching by all the search function sections 111-1 to 111-n (or 401-1 to 401-n) had been completed. However, it could be arranged for decision function section 112 to execute logical product calculation at the stage where a prescribed number (two or more) of search results have been input, and for the logical product calculation to be performed of the new search results and the result of the logical product calculation on the previous occasion every time a search result is input thereafter. This calculation result is identical with the calculation result that would be obtained if logical product calculation were performed in respect of all the search results. By performing the logical product calculation every time a new search result is input, the overall processing time can be further shortened compared with the case where logical product processing is performed after all the search results have been determined.

As described in detail above, with the present invention, a datagram transmission device can be provided whereby route searching and other searching can be executed at high speed.

What is claimed is:

1. A datagram transmission device comprising:
first search means that reads the destination address from a received datagram and searches for a transmission control rule corresponding to the destination address;
one or a plurality of second search means that reads prescribed information other than the destination address information from said datagram and that searches for a transmission control rule corresponding to the information that has thus been read;
decision means that respectively inputs search results from said first and second search means and determines said transmission control rule contained in the search results of all of said search means; and
execution means that executes transmission control in accordance with said transmission control rule determined by said decision means.

2. The datagram transmission device according to claim 1 wherein said first search means and said second search means perform said searches in parallel.

3. The datagram transmission device according to claim 1 wherein said transmission control rules that are searched are stored for each of said search means.

4. The datagram transmission device according to claim 1 wherein, if there are a plurality of entries of the same said transmission control rule, said transmission control rule is stored as one or other entry and storage position information of said transmission control rule is stored as the other entries.

5. The datagram transmission device according to claim 4 wherein said storage position information is information in bit map form.

6. The datagram transmission device according to claim 1 wherein said second search means employs information belonging to the third layer of the protocol or a layer above this as said information.

7. The datagram transmission device according to claim 1 wherein said second search means employs information belonging to the second layer of the protocol as said information.

8. The datagram transmission device according to claim 7 wherein the information belonging to said second layer is information indicating a virtual channel identifier of asynchronous transfer mode.

9. The datagram transmission device according to claim 8 wherein said transmission control rule is orientation information.

10. The datagram transmission device according to claim 1 wherein said decision means, after inputting all of the search results of said first and second search means, calculates the logical product of these search results, and outputs the result of this calculation as the decision result.

11. The datagram transmission device according to claim 10 wherein, if said transmission control rule obtained by said first search means is only transmission route information, said transmission route information is output as the decision result without carrying out said logical product calculation.

12. The datagram transmission device according to claim 11 wherein, if it is ascertained that said transmission control rule obtained by said first search means is only transmission route information, a control signal is output for interrupting the operation of said second search means.

13. The datagram transmission device according to claim 1 wherein, every time said decision means inputs said transmission control rule as the search result from said first and second search means, said decision means calculates the logical product between the logical product of said search results that have already been input and said newly input transmission control rule, and outputs the final calculation result as the decision result.

14. The datagram transmission device according to claim 13 wherein, if said transmission control rule obtained by said first search means is only transmission route information, said transmission route information is output as the decision result without subsequently performing said logical calculation.

15. The datagram transmission device according to claim 14 wherein, if it is ascertained that said transmission control rule obtained by said first search means is only transmission route information, a control signal is output for interrupting operation of said second search means.

16. The datagram transmission device according to claim 1 wherein said first and second search means perform searching using a dichotomizing search method.

17. The datagram transmission device according to claim 1 wherein said first and second search means perform searching using the 2^{P} search method.

18. The datagram transmission device according to claim 1 wherein said datagram transmission device is an Internet protocol router.

19. The datagram transmission device according to claim 1 wherein said datagram transmission device is an Internet protocol switch.

20. The datagram transmission device according to claim 1 wherein said datagram is an Internet protocol packet.
